(19) United States
(12) Patent Application Publication
(10) Pub. No.: US 2013/0074963 A1
(43) Pub. Date: Mar. 28, 2013

(54) FAUCET

(71) Applicant: Yu-Liang Hsu, Changhua County (TW)

(72) Inventor: Yu-Liang Hsu, Changhua County (TW)

(73) Assignee: Yu-Liang Hsu, Changhua County (TW)

(21) Appl. No.: 13/241,056

(22) Filed: Sep. 22, 2011

(51) Int. Cl. F16K 51/00

(52) U.S. Cl. 137/801

(57) ABSTRACT

A faucet has a main body, a limiting ring and a handle device. The main body has a connecting section and a switch bar. The connecting section is formed on and protrudes from a top of the main body. The switch bar is movably mounted in the connecting section. The limiting ring is rotatably mounted around the connecting section and has a block. The handle device is securely connected with the switch bar. The limiting ring is located between the handle device and the main body. The block protrudes relative to the handle device. With the limiting ring, the handle device can be restricted by the limiting ring and the faucet can avoid being accidentally switched on by a child.

### BACKGROUND OF THE INVENTION

1. Field of the Invention

The present invention relates to a faucet, and more particularly to a faucet having a safe mechanism.

2. Description of Related Art

A conventional faucet has a main body and a handle device. The main body has a movable switch bar with which the handle device is securely connected. A handle of the handle device can be lifted upwardly or pressed downwardly to drive the switch bar and to switch on or off the faucet.

However, the conventional faucet is easily switched on by a child because the faucet lacks a safe structure to lock the handle. Consequently, accidents easily happen and cause injuries of children.

Because the conventional faucet can be accidentally switched on, water easily leaks and water source is wasted.

To overcome the shortcomings, the present invention tends to provide a faucet to mitigate the aforementioned problems.

### SUMMARY OF THE INVENTION

The main objective of the invention is to provide a faucet having a safe mechanism.

A faucet has a main body, a limiting ring and a handle device. The main body has a connecting section and a switch bar. The connecting section is formed on and protrudes from a top of the main body. The switch bar is movably mounted in the connecting section. The limiting ring is rotatably mounted around the connecting section and has a block. The handle device is securely connected with the switch bar. The limiting ring is located between the handle device and the main body. The block protrudes relative to the handle device. With the limiting ring, the handle device can be restricted by the limiting ring and the faucet can avoid being accidentally switched on by a child.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a faucet in accordance with the present invention;

FIG. 2 is a partially exploded perspective view of the faucet in FIG. 1;

FIG. 3 is an enlarged side view in partial section of the main body of the faucet in FIG. 1;

FIG. 4 is an enlarged perspective view of the limiting ring of the faucet in FIG. 1;

FIG. 5 is an enlarged operational view of the faucet in FIG. 1;

FIG. 6 is a side view in partial section of the faucet in FIG. 1;

FIG. 7 is an operational view of the faucet in FIG. 6;

FIG. 8 is an enlarged perspective view of the limiting ring of a second embodiment of the faucet in accordance with the present invention; and

FIG. 9 is a side view in partial section of a third embodiment of the faucet in accordance with the present invention.

### DETAILED DESCRIPTION OF PREFERRED EMBODIMENT

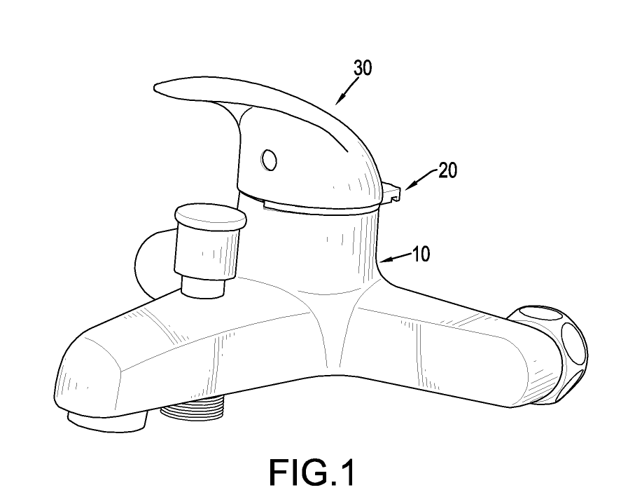

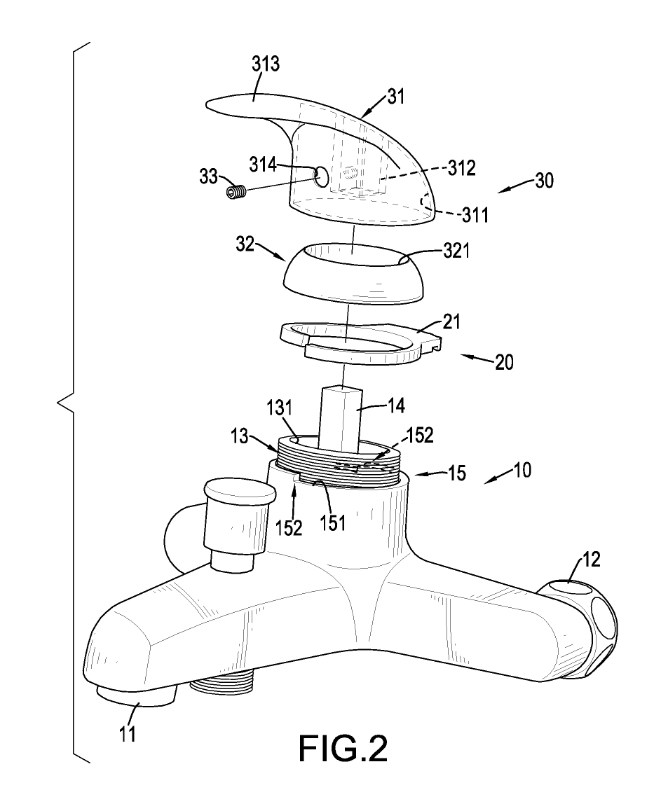

With reference to FIGS. 1 and 2, a first embodiment of a faucet in accordance with the present invention comprises a main body 10, a limiting ring 20 and a handle device 30.

The main body 10 has a top, a front end, an outlet 11, at least one inlet 12, a connecting section 13 and a switch bar 14. The outlet 11 is formed in the front end of the main body 10. Preferably, two inlets 12 are implemented and are respectively formed at opposite sides of the main body 10. The inlets 12 are formed in the main body 10 beside the outlet 11.

The connecting section 13 is formed on and protrudes out from the top of the main body 10 and has a top and a body recess 131. The body recess 131 is hollow and is axially formed in the top of the connecting section 13. The switch bar 14 is movable and is mounted in the body recess 131 of the connecting section 13. The switch bar 14 can be rotated about 45° (degree) clockwise or counterclockwise to switch to hot water or cold water and can also be pivoted to switch on or off the faucet.

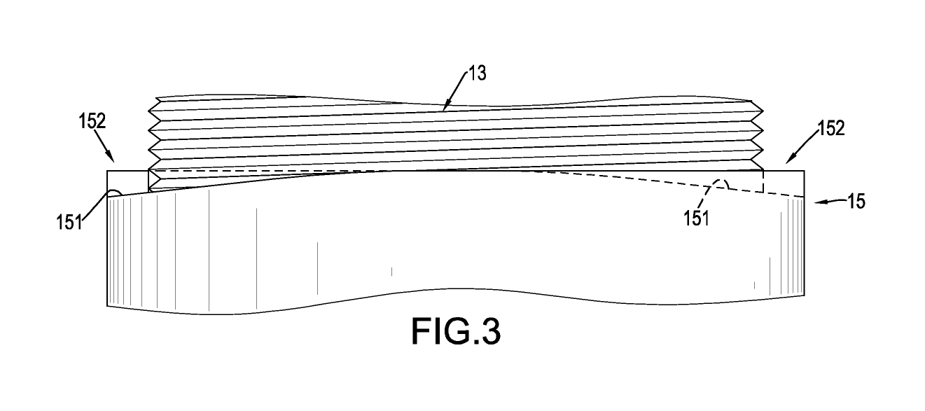

With further reference to FIG. 3, preferably, the main body 10 has an annular abutted surface 15 formed on the top of the main body 10 beside the connecting section 13 and located around the connecting section 13.

The abutted surface 15 has two inclined segments 151 and two steps 152. Each inclined segment 151 has two ends respectively adjacent to those of the other inclined segment 151. The steps 152 are respectively formed on where the ends of the inclined segments 151 are adjacent. The steps 152 are defined as a front step facing a front of the faucet and a rear step facing a rear of the faucet. Each step 152 has a height.

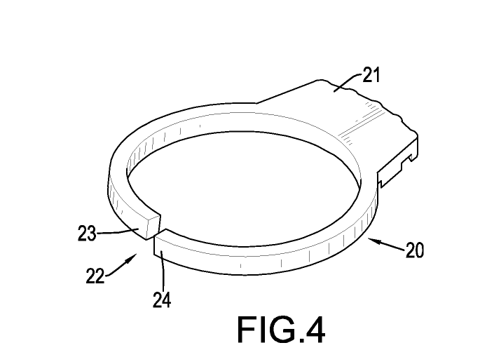

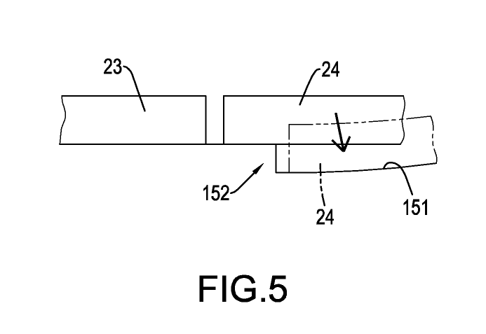

With reference to FIGS. 2, 4 and 5, the limiting ring 20 is rotatably mounted around the connecting section 13, is adjacent to the body recess 131, abuts the abutted surface 15 and has a block 21 protruding from an outer surface of the limiting ring 20. Preferably, the limiting ring 20 is C-shaped and has a breach 22, a first end 23 and a second end 24. The breach 22 is located at a position opposite to the block 21. The first end 23 and the second end 24 of the limiting ring 20 misalign each other. The second end 24 of the limiting ring 20 is located below the first end 23 of the limiting ring 20. A height difference is formed between bottoms of the first end 23 and the second end 24 of the limiting ring 20. The height difference is the same as the height of each step 152. Accordingly, the limiting ring 20 can be only rotated in a specific rotational direction, preferably counterclockwise, because the steps 152 restrict the reverse rotational direction of the limiting ring 20.

Moreover, when the limiting ring 20 is rotated counterclockwise, the second end 24 is gradually lifted by one of the inclined segments 151. When the second end 24 moves across the front step or the rear step, the second end 24 suddenly drops and hits the other inclined segment 151 to make a sound that informs the user the block 21 has been moved to the front step or the rear step.

With reference to FIGS. 1, 2 and 6, the handle device 30 is securely connected with the switch bar 14 and has a handle 31, a bowl 32 and an inner hexagonal screw 33.

The handle 31 has a top, a bottom, a handle recess 311, a mounting section 312, a held section 313 and a through hole 314. The handle recess 311 is formed in the bottom of the handle 31, encompasses the connecting section 13 and has an inner surface.

The mounting section 312 is formed on and protrudes from the inner surface of the handle recess 311 and is securely mounted around the switch bar 14. The mounting section 312 has a rectangular cross section.

The held section 313 is formed on the top of the handle 31. The limiting ring 20 is located between the bottom of the handle 31 and the top of the main body 10 and the block 21 protrudes relative to the handle 31.

The through hole 314 is formed through the handle 31.

The bowl 32 is securely mounted around the connecting section 13 by threads, is located in the handle recess 311 and has a bottom and a bowl hole 321. The bottom of the bowl 32 abuts the limiting ring 20. The bowl hole 321 is axially formed through the bowl 32 and encompasses the switch bar 14 and the mounting section 312.

The inner hexagonal screw 33 is mounted in the handle 31, aligns the through hole 314 and is inserted into the mounting section 312 to press the switch bar 14.

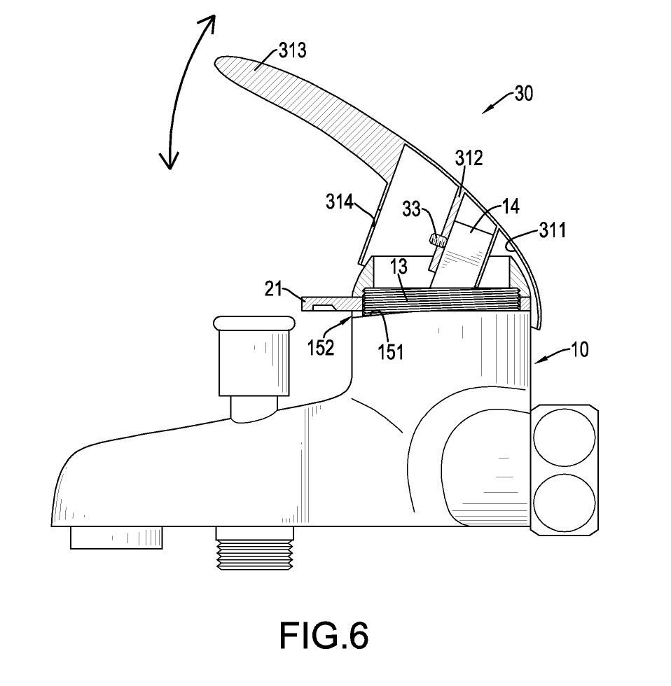

With reference to FIG. 6, the block 21 is adjacent to the front step to face the front of the faucet. The held section 313 is held by a hand and can be lifted upwardly or pressed downwardly to drive the movable switch bar 14. Consequently, the faucet can be switched on or off because the movement of a rear of the handle 31 is not restricted by the block 21. Accordingly, the handle 31 can be operated normally.

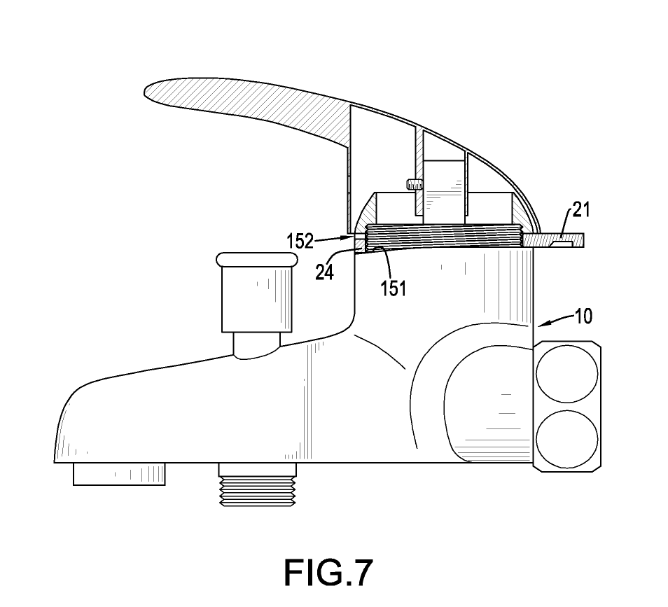

With reference to FIG. 7, the limiting ring 20 is rotated 180° (degree) and the block 21 is adjacent to the rear step to face the rear of the faucet. Consequently, the faucet cannot be switched on because movement of the rear of the handle 31 is restricted by the block 21. With the limiting ring 20, the handle 31 will not be accidentally switched on by a child and safety is thus greatly enhanced.

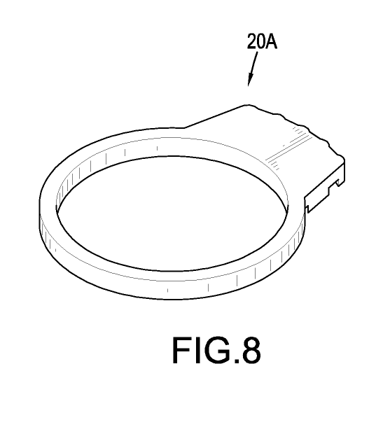

With reference to FIG. 8, a second embodiment of the faucet in accordance with the present invention is substantially the same as the first embodiment except the limiting ring 20A is a closed ring and does not have the breach 22. Accordingly, the limiting ring 20A does not make a sound when the limiting ring 20A is rotated.

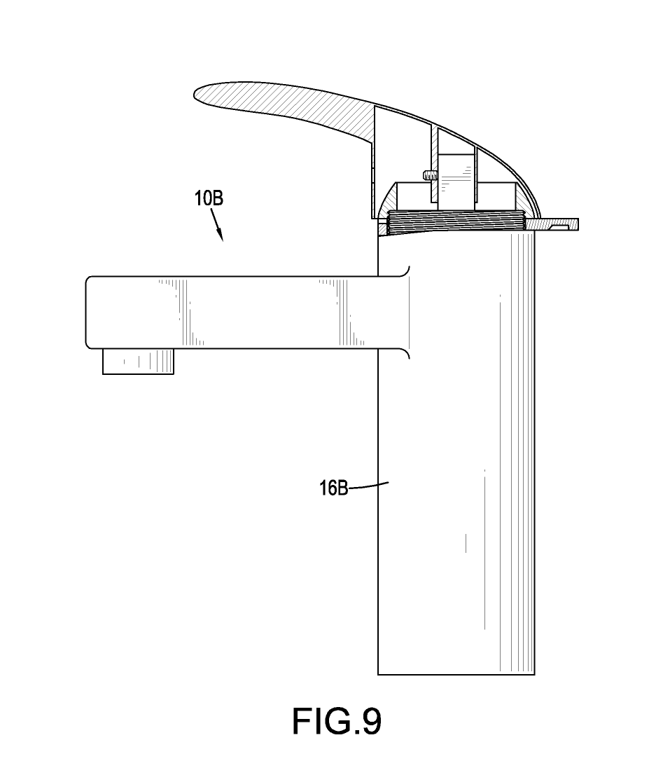

With reference to FIG. 9, a third embodiment of the faucet in accordance with the present invention is substantially the same as the first embodiment except the main body 10B has a rod section 16B. The rod section 16B is hollow and has a tubular inner space and two inlets communicating with the inner space. Because the inlets are hidden inside the rod section 16B, appearance of the main body 10B is simple and compact.

From the above description, it is noted that the present invention has the following advantages:

1. Safe mechanism:

With the limiting ring 20 being rotated to the rear step of the abutted surface 15, the handle 31 can be restricted by the limiting ring 20 and the faucet can avoid being accidentally switched on by a child. Consequently, the faucet has a safe mechanism and is safe for use.

2. Informing sound:

The limiting ring 20 can make a sound when the second end 23 crosses the front step or the rear step and this is very convenient for user to know the block 21 is moved to a specific position.

3. Water saving:

Because the faucet can avoid being accidentally switched on, water leaking is prevented and water is also saved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A faucet comprising:
a main body having
a top;
a front end;
an outlet formed in the front end of the main body;
at least one inlet formed in the main body beside the outlet;
a connecting section formed on and protruding out from the top of the main body and having
a top; and
a round body recess formed in the top of the connecting section; and
a movable switch bar mounted in the body recess;
a limiting ring rotatably mounted around the connecting section, adjacent to the body recess and having a block protruding from an outer surface of the limiting ring; and
a handle device securely connected with the switch bar and having
a handle having
a top;
a bottom;
a handle recess formed in the bottom of the handle, encompassing the connecting section and having an inner surface;
a mounting section formed on and protruding from the inner surface of the handle recess and securely connected with the switch bar; and
a held section formed on the top of the handle, wherein the limiting ring is located between the bottom of the handle and the top of the main body and the block protrudes relative to the handle.

2. The faucet as claimed in claim 1, wherein
the main body has an annular abutted surface formed on the top of the main body beside the connecting section, located around the connecting section and abutted by the limiting ring.

3. The faucet as claimed in claim 2, wherein
the abutted surface has two inclined segments and two steps;
each inclined segment has two ends respectively adjacent to those of the other inclined segment; and
the steps are respectively formed on where the ends of the inclined segments are adjacent and the steps respectively face a front and a rear of the faucet.

4. The faucet as claimed in claim 3, wherein
the limiting ring is C-shaped and has
a breach located at a position opposite to the block;
a first end;
a second end misaligning the first end of the limiting ring and located below the first end of the limiting ring; and
a height difference formed between bottoms of the first end and the second end of the limiting ring; and
each step has a height the same as the height difference of the limiting ring.

5. The faucet as claimed in claim 1, wherein
the handle device has a bowl; and
the bowl is securely mounted around the connecting section by threads, is located in the handle recess and has
a bottom abutting the limiting ring; and
a bowl hole axially formed through the bowl and encompassing the switch bar and the mounting section.

6. The faucet as claimed in claim 2, wherein
the handle device has a bowl; and
the bowl is securely mounted around the connecting section by threads, is located in the handle recess and has
a bottom abutting the limiting ring; and
a bowl hole axially formed through the bowl and encompassing the switch bar and the mounting section.

7. The faucet as claimed in claim 3, wherein
the handle device has a bowl; and
the bowl is securely mounted around the connecting section by threads, is located in the handle recess and has
a bottom abutting the limiting ring; and
a bowl hole axially formed through the bowl and encompassing the switch bar and the mounting section.

8. The faucet as claimed in claim 4, wherein
the handle device has a bowl; and
the bowl is securely mounted around the connecting section by threads, is located in the handle recess and has
a bottom abutting the limiting ring; and
a bowl hole axially formed through the bowl and encompassing the switch bar and the mounting section.
